(19) United States
(12) Patent Application Publication
(10) Pub. No.: US 2014/0117639 A1
(43) Pub. Date: May 1, 2014

(54) Mechanical Spring Axle/Suspension System for Heavy-Duty Vehicles

(71) Applicant: HENDRICKSON USA, L.L.C., Itasca, IL (US)

(72) Inventor: John E. Ramsey, Canton, OH (US)

(73) Assignee: HENDRICKSON USA, L.L.C., Itasca, IL (US)

(21) Appl. No.: 14/061,832

(22) Filed: Oct. 24, 2013

Related U.S. Application Data
(60) Provisional application No. 61/718,767, filed on Oct. 26, 2012.

(51) Int. Cl. B60G 9/04

(52) U.S. Cl. CPC B60G 9/04
USPC 280/124.11

(57) ABSTRACT

A mechanical spring axle/suspension system includes a front axle/suspension system and a rear axle/suspension system. The front system includes a pair of front leaf spring stacks, and a front axle extending between and being connected to the front leaf spring stacks. A front end of a leaf spring of each front spring stack includes a spring eye that is pivotally connected to a front hanger, and a rear end disposed on a cam mounted in an equalizer. The rear system includes a pair of rear leaf spring stacks, and a rear axle extending between and being connected to the rear leaf spring stacks. A front end of a leaf spring of each rear spring stack includes a spring eye that is pivotally connected to an equalizer, in which the spring eye position reduces inter-axle load transfer, and a rear end disposed on a cam mounted in a rear hanger.

### CROSS-REFERENCE TO RELATED APPLICATIONS

This application claims the benefit of U.S. Provisional Patent Application Ser. No. 61/718,767, which was filed on Oct. 26, 2012.

### BACKGROUND OF THE INVENTION

1. Technical Field

The present invention relates to the art of axle/suspension systems for vehicles. More particularly, the invention relates to the art of mechanical spring axle/suspension systems for heavy-duty vehicles, such as tractor-trailers or semi-trailers, which locate the vehicle axle(s) and stabilize the vehicle during operation. Still more particularly, the invention relates to a mechanical spring axle/suspension system that incorporates springs formed with eyes and an optimized connection of a rear spring to the vehicle frame or subframe, which minimizes inter-axle load transfer due to braking and also minimizes stress on the vehicle frame or subframe.

2. Background Art

Heavy-duty vehicles that transport freight, for example, tractor-trailers or semi-trailers and straight trucks, include suspension assemblies that connect the axles of the vehicle to the frame of the vehicle. In some heavy-duty vehicles, the suspension assemblies are connected directly to the primary frame of the vehicle. In other heavy-duty vehicles, the primary frame of the vehicle supports a subframe, and the suspension assemblies connect directly to the subframe. For those heavy-duty vehicles that support a subframe, the subframe can be non-movable or movable, the latter being commonly referred to as a slider box, slider subframe, slider undercarriage, or secondary slider frame. For the purpose of convenience, reference herein will be made to a subframe, with the understanding that such reference is by way of example, and that the present invention applies to heavy-duty vehicle primary frames, movable subframes and non-movable subframes.

In the heavy-duty vehicle art, reference is often made to an axle/suspension system, which typically includes a pair of transversely-spaced suspension assemblies and the axle that the suspension assemblies connect to the vehicle subframe. The axle/suspension system of a heavy-duty vehicle acts to locate or fix the position of the axle and to stabilize the vehicle. More particularly, as the vehicle is traveling over-the-road, its wheels encounter road conditions that impart various forces to the axle on which the wheels are mounted, and in turn, to the suspension assemblies that are connected to and support the axle. These forces consequently act to place or create loads on the axle and the suspension assemblies. In order to minimize the detrimental effect of these forces and resulting loads on the vehicle subframe and other vehicle components as the vehicle is operating, and in turn on any cargo and/or occupants being carried by the vehicle, the axle/suspension system is designed to absorb or dampen at least some of the forces and/or resulting loads.

Two common types of heavy-duty vehicles are known in the art as dry freight vans and refrigerated vans. Dry freight vans include enclosed trailers to keep their freight dry, and are used to transport a wide variety of non-perishable consumer and industrial goods. Refrigerated vans include enclosed trailers with refrigeration systems, and typically are used to transport perishable goods. Such dry freight vans and refrigerated vans have traditionally employed axle/suspension systems that utilize mechanical spring axle/suspension assemblies. These mechanical spring axle/suspension assemblies typically include a pair of leaf spring sets or stacks that are transversely spaced and are connected to the axle. Each leaf spring stack is engineered to carry the rated vertical load of its respective axle. Ordinarily, a trailer of a dry freight or refrigerated van employs two mechanical spring axle/suspension systems at the rear of the trailer, that is, a front axle/suspension system and a rear axle/suspension system, which is a configuration that is collectively referred to in the art as a trailer tandem axle/suspension system. As is known to those skilled in the art, the front end of the trailer is supported by a separate axle/suspension system of the tractor. For the purpose of convenience, reference herein shall be made to a spring axle/suspension system with the understanding that such reference is to a trailer tandem mechanical spring axle/suspension system.

With prior art spring axle/suspension system designs, a heavy braking application of the vehicle creates forces that increase the load on the rear axle and decrease the load on the front axle. This increased load on the rear axle and decreased load on the front axle during braking is often referred to as inter-axle load transfer. Inter-axle load transfer during braking decreases the effectiveness of the front axle for braking, which in turn causes uneven braking of the vehicle, thereby decreasing braking or stopping efficiency and undesirably increasing the stopping distance of the vehicle. Moreover, the front axle may skip or skid during a heavy braking application, creating flat spots on the tires, thereby undesirably increasing tire wear.

It is understood that, as mentioned above, each one of the front and rear spring axle/suspension systems includes a generally identical pair of transversely-spaced, longitudinally-extending leaf spring sets or stacks, each one of which is disposed on a respective one of the driver's side and passenger side of the vehicle. Inasmuch as each leaf spring set of each front and rear spring axle/suspension system is generally identical to the other, only one of each of the front and rear leaf spring sets will be described herein. In the prior art, spring axle/suspension systems have utilized a mechanical component, such as a load leveler or equalizer beam, mounted between the leaf spring stack of the front axle/suspension system and the leaf spring stack of the rear axle/suspension system. The equalizer beam is intended to balance the loads between the front and rear axles when traversing road surface irregularities, but is generally unable to provide optimum inter-axle load transfer during braking.

Prior art spring axle/suspension systems have also employed radius rods, which are separate components that extend between each axle and a respective vehicle subframe member, and are intended to maintain axle alignment and to react brake forces and other fore-aft forces. However, radius rods typically are unable to reduce inter-axle load transfer during braking, as will be described in greater detail below. Also, because each radius rod is a separate component, it undesirably adds weight and expense to the spring axle/suspension system. In addition, radius rods may need to be replaced when performing alignment of the spring axle/suspension system, thereby undesirably increasing the expense that is associated with the system. It is known in the art that the lower a radius rod is positioned relative to the ground, the amount of undesirable inter-axle load transfer during braking is reduced, due to reduced axle rotation. However, a low mounting position of a radius rod tends to create a moment arm that undesirably increases the stress on the vehicle subframe.

Other prior art designs of spring axle/suspension systems do not include radius rods, but are undesirably subject to greater axle rotation due to braking, which is known in the art as brake wind-up. More particularly, such prior art designs locate the eyes of the mechanical springs directly in horizontal alignment with the equalizer bushing. This horizontal alignment precludes counter-rotational movement that would be necessary to counteract brake wind-up. In addition, in such prior art spring axle/suspension systems that do not include radius rods, it is often difficult to properly align the axles.

As a result, a need has existed in the art for a spring axle/suspension system that overcomes the disadvantages of prior art systems by reducing inter-axle load transfer due to braking without the use of radius rods, improving the distribution of forces encountered by the axle/suspension system, decreasing the stresses placed on the vehicle subframe, and reducing brake wind-up, while being lighter in weight and more economical than prior art spring axle/suspension systems. The spring axle/suspension system of the present invention satisfies this need, as will be described below.

### BRIEF SUMMARY OF THE INVENTION

An objective of the present invention is to provide a spring axle/suspension system that reduces inter-axle load transfer due to braking without the use of radius rods.

Another objective of the present invention is to provide a spring axle/suspension system that improves the distribution of forces encountered by the axle/suspension system.

Still another objective of the present invention is to provide a spring axle/suspension system that decreases the stresses placed on the vehicle subframe.

Yet another objective of the present invention is to provide a spring axle/suspension system that reduces brake wind-up.

A further objective of the present invention is to provide a spring axle/suspension system that is lighter in weight and more economical than prior art spring axle/suspension systems.

This objective and others are obtained by the mechanical spring axle/suspension system of the present invention. In an exemplary embodiment of the invention, a heavy-duty vehicle has a frame including a pair of spaced-apart, parallel, elongated, and longitudinally-extending main members, at least a pair of transverse cross members extending between and being attached to the main members, a pair of front hangers, each one of which is attached to and depends from a front end of a respective one of the main members, a pair of center hangers, each one of which is attached to and depends from a center portion of a respective one of the main members, a pair of rear hangers, each one of which is attached to and depends from a rear end of a respective one of the main members, and a pair of equalizers, each one of which is pivotally connected to a respective one of the center hangers. The mechanical spring axle/suspension system includes a front axle/suspension system, which in turn includes a pair of transversely-spaced front leaf spring stacks, in which each front spring stack includes at least one leaf spring extending longitudinally between a respective one of the front hangers and a respective one of the equalizers. The at least one leaf spring of the front spring stack includes a front end formed with a spring eye, in which the spring eye is pivotally connected to a respective one of each of the front hangers, and a rear end that is slideably disposed on a cam mounted in a respective one of the equalizers. A front axle extends between and is rigidly connected to each one of the pair of front leaf spring stacks. The mechanical spring axle/suspension system also includes a rear axle/suspension system, which in turn includes a pair of transversely-spaced rear leaf spring stacks, in which each rear spring stack includes at least one leaf spring extending longitudinally between a respective one of the equalizers and a respective one of the rear hangers. The at least one leaf spring of the rear spring stack includes a front end formed with a spring eye, in which the spring eye is pivotally connected to a respective one of each of the equalizers, and wherein a vertical position of the pivotal connection of the at least one leaf spring of the rear spring stack to the respective one of the equalizers is below a vertical position of the pivotal connection of the respective equalizer to the respective one of the center hangers. The at least one leaf spring of the rear spring stack includes a rear end slideably disposed on a cam that is mounted in a respective one of the rear hangers. A rear axle extends between and is rigidly connected to each one of the pair of rear leaf spring stacks, and inter-axle load transfer encountered by the mechanical spring axle/suspension system is minimized.

### BRIEF DESCRIPTION OF THE SEVERAL VIEWS OF THE DRAWINGS

The preferred embodiment of the invention, illustrative of the best mode in which Applicant has contemplated applying the principles of the invention, is set forth in the following description and is shown in the drawings, and is particularly and distinctly pointed out and set forth in the appended claims.

FIG. 1 is a driver's side top-front perspective view of a first prior art trailer tandem mechanical spring axle/suspension assembly, shown in an over-slung configuration and mounted on a vehicle subframe;

FIG. 2 is a driver's side elevational view of the spring axle/suspension system shown in FIG. 1, with hidden components represented by broken lines;

FIG. 3 is a driver's side elevational schematic view of a second prior art trailer tandem mechanical spring axle/suspension system, shown in an over-slung configuration and mounted on a vehicle subframe, and with tires and certain other components represented by broken lines;

FIG. 4 is a driver's side elevational view of a third prior art trailer tandem mechanical spring axle/suspension system, shown in an under-slung configuration;

FIG. 5 is a driver's side top-front perspective view of an exemplary embodiment of the trailer tandem mechanical spring axle/suspension system of the present invention, shown in an over-slung configuration and mounted on a vehicle subframe, with brake system components mounted thereon and driver's side brake pads represented by broken lines;

FIG. 6 is a driver's side elevational view of the spring axle/suspension system shown in FIG. 5, with hidden components represented by broken lines, and certain brake components removed;

FIG. 7 is an enlarged fragmentary driver's side bottom perspective view of a leaf spring stack, an axle, and a clamp assembly of one of the spring axle/suspension systems shown in FIG. 5, without brake system components mounted thereon.

Similar numerals refer to similar parts throughout the drawings.

### DETAILED DESCRIPTION OF THE INVENTION

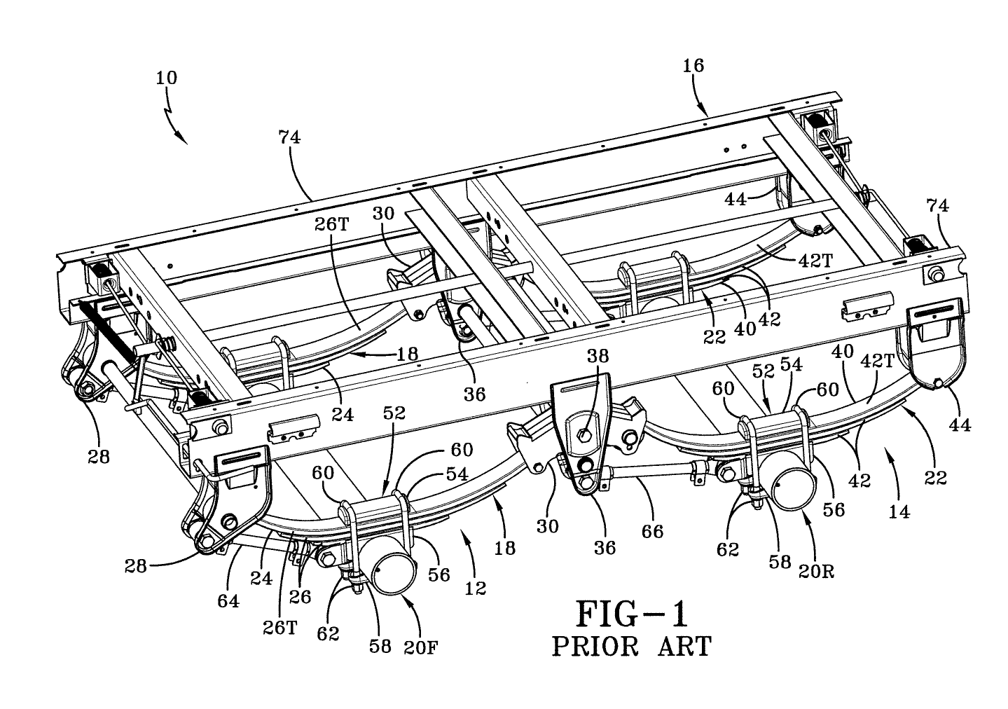

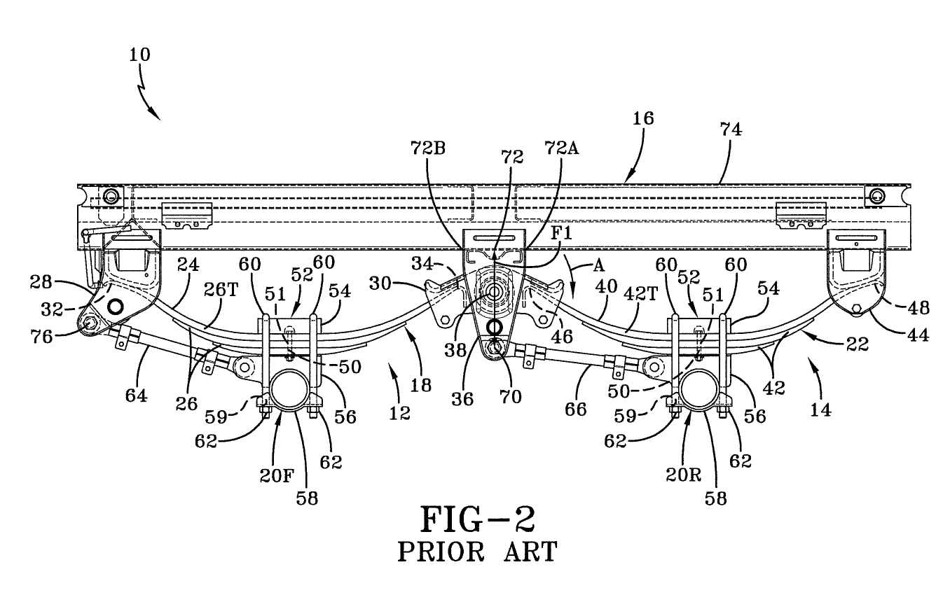

In order to better understand the spring axle/suspension system for heavy-duty vehicles of the present invention, a first prior art spring axle/suspension system is indicated generally at 10 and is shown in FIGS. 1 and 2. Shown prior art spring axle/suspension system 10 is a tandem axle/suspension system, utilizing a front axle/suspension system 12 and a rear axle/suspension system 14, each of which is connected to and depends from a vehicle frame or subframe 16, as known in the art. As mentioned above, in some heavy-duty vehicles, the axle/suspension systems are connected directly to the primary frame of the vehicle, while in other heavy-duty vehicles, the primary frame of the vehicle supports a movable or non-movable subframe, and the axle/suspension systems connect directly to the subframe. For the purpose of convenience, reference herein will be made to subframe 16, with the understanding that such reference is by way of example, and that the present invention applies to heavy-duty vehicle primary frames, movable subframes and non-movable subframes.

Front axle/suspension system 12 includes a pair of transversely-spaced, longitudinally-extending mechanical spring suspension assemblies 18, which connect to a front axle 20F. Similarly, rear axle/suspension system 14 includes a pair of transversely-spaced, longitudinally-extending mechanical spring suspension assemblies 22, which connect to a rear axle 20R. Inasmuch as each one of the pair of front mechanical spring suspension assemblies 18 is identical to the other, and each one of the pair of rear mechanical spring suspension assemblies 22 is identical to the other, only one of each will be described herein.

Front mechanical spring suspension assembly 18 includes a leaf spring set or stack 24, which in turn includes a plurality of leaf springs 26. Rear mechanical spring suspension assembly 22 includes a leaf spring set or stack 40, which in turn includes a plurality of leaf springs 42. It is to be noted that first prior art spring axle/suspension system 10 is shown in FIGS. 1 and 2 in what is referred to in the art as an over-slung configuration, in which front spring stack 24 is disposed above front axle 20F and rear spring stack 40 is disposed above rear axle 20R.

Turning first to front mechanical spring suspension assembly 18, top leaf spring 26T of each spring stack 24 extends longitudinally between a front hanger 28, which is mounted on and depends from subframe 16 in a manner known to those skilled in the art, and an equalizer or rocker 30. More particularly, a front end 32 of top spring 26T is formed to enable the front end of the top spring to rest on and engage a cam or slipper block (not shown) that is mounted in front hanger 28. A rear end 34 of top spring 26T is formed to enable the rear end of the top spring to rest on and engage a cam or slipper block (not shown) that is mounted in equalizer 30. Equalizer 30 in turn is pivotally connected to a center hanger 36 by a pin and bushing assembly 38, and the center hanger is mounted on and depends from subframe 16 as known in the art. This construction enables top spring 26T and thus front spring stack 24 to float or slide at front and center hangers 28, 36, respectively, to respond to certain load conditions. As known in the art, equalizer 30 also provides a connection between front and rear suspension assemblies 18, 22, respectively, and pivots in order to attempt to balance the loads between front and rear axles 20F, 20R.

Turning next to rear mechanical spring suspension assembly 22, top leaf spring 42T of each spring stack 40 extends longitudinally between equalizer 30 and a rear hanger 44, which is mounted on and depends from subframe 16 as known in the art. More particularly, a front end 46 of top spring 42T is formed to enable the front end of the top spring to rest on and engage a cam or slipper block (not shown) that is mounted in equalizer 30. A rear end 48 of top spring 42T is formed to enable the rear end of the top spring to rest on and engage a cam or slipper block (not shown) that is mounted in rear hanger 44. In this manner, top spring 42T and thus rear spring stack 40 are able to float or slide at center and rear hangers 36, 44, respectively, to respond to certain load conditions.

The plurality of leaf springs 26 of front leaf spring stack 24 are held together by a center bolt 50, and are clamped to front axle 20F by a clamp assembly 52. More particularly, center bolt 50 extends through an opening 51 formed in each one of front leaf springs 26 at about the longitudinal midpoint of each one of the springs, and interconnects the springs. Clamp assembly 52 includes a top block 54 that is disposed on the upper surface of top spring 26T at about the longitudinal midpoint of the top spring, a top axle seat 56 that extends between the bottom of front spring stack 24 and the upper portion of front axle 20F in vertical alignment with the top block, and a bottom axle seat 58 which is disposed on the lower portion of the front axle in vertical alignment with the top block and the top axle seat. Clamp assembly 52 also includes a pair of U-bolts 60, each one of which engages top block 54 and extends through a pair of openings 59 formed in bottom axle seat 58. In this manner, top block 54, front spring stack 24, top axle seat 56, axle 20F, and bottom axle seat 58 are rigidly clamped together when nuts 62 are tightened onto U-bolts 60. It is understood that leaf springs 42 of rear leaf spring stack 40 are held together by center bolt 50 and are clamped to rear axle 20R by clamp assembly 52 in a manner similar to that as described for front leaf springs 26 of front leaf spring stack 24.

In order to control fore-aft movement of front axle 20F, a front radius rod 64 is pivotally connected to and extends between front hanger 28 and front axle top axle seat 56. Likewise, to control fore-aft movement of rear axle 20R, a rear radius rod 66 is pivotally connected to and extends between center hanger 36 and rear axle top axle seat 56. A brake chamber mounting bracket (not shown) is attached to each axle 20F, 20R, typically by welding, inboardly of top axle seat 56 to enable the mounting of brake system components (not shown) on spring axle/suspension system 10.

This design of first prior art spring axle/suspension system 10 enables the system to generally adequately react the forces that act on the system and the resulting loads that are encountered by the system. However, prior art spring axle/suspension system 10 requires the use of radius rods 64, 66, which undesirably add weight and cost to the system.

In addition, prior art spring axle/suspension system 10 experiences inter-axle load transfer due to braking. As described above, during a heavy braking application, the resulting forces create inter-axle load transfer between front axle/suspension system 12 and rear axle/suspension system 14, which undesirably increases the stopping distance of the vehicle. While radius rods 64, 66 control fore-aft loads on each respective axle 20F, 20R and corresponding fore-aft movement of each axle, they often are unable to reduce inter-axle load transfer due to braking. More particularly, during a heavy brake application, the forces that are experienced by front suspension assembly 18 and rear suspension assembly 22 cause equalizer 30 to pivot in a clockwise manner. Arrow A in FIG. 2 shows the resulting rotation of equalizer 30 due to the forces acting at front and rear axles 20F, 20R. This pivoting or rotation of equalizer 30, despite the presence of radius rods 64, 66, creates increased loads on rear axle 20R and decreased loads on front axle 20F, thereby enabling inter-axle load transfer to take place. As described above, such inter-axle load transfer during braking decreases the effectiveness of the front axle for braking, which in turn causes uneven braking of the vehicle, thereby decreasing braking or stopping efficiency and undesirably increasing the stopping distance of the vehicle. In addition, the inter-axle load transfer may cause the front axle to skip or skid during a heavy braking application, which creates flat spots on the tires and thereby undesirably increases tire wear.

In order to attempt to reduce inter-axle load transfer due to braking in prior art spring axle/suspension systems that employ radius rods 64, 66 which are connected to respective hangers 28, 36, such as spring axle/suspension system 10, it has been shown that it is desirable to vertically lower the position of the pivotal connection between rear radius rod 66 and center hanger 36. More particularly, as described in a 1985 SAE Technical Paper entitled “Controlled Load Transfer during Braking on a Four-Spring Trailer Suspension” by Phil R. Pierce, inter-axle load transfer is desirably reduced as the pivotal connection point of rear radius rod 66 to center hanger 36 approaches the ground. This pivotal connection point is indicated by way of example in FIG. 2 as point 70. However, lowering or moving connection point 70 closer to the ground also increases the vertical moment arm at center hanger 36 and front hanger 28, which undesirably increases the stress on subframe 16 and related components.

More specifically, with reference to center hanger 36 by way of example, certain longitudinal forces acting on rear axle/suspension system 14 are transmitted to the center hanger at point 70, which, as described above, is the connection point of rear radius rod 66 to the hanger. These forces are in turn multiplied by the vertical distance between point 70 and the bottom of subframe main member 74 at point 72. This vertical distance between points 70 and 72 is indicated by arrow F1 in FIG. 2. The multiplication of the forces acting at point 70 by distance F1 produces a moment of force that is reacted generally at points 72A and 72B, which are the attachment points of center hanger 36 to the bottom of subframe main member 74. If point 70 is moved closer to the ground, the force acting at point 72 and points 72A, 72B is undesirably increased, which in turn undesirably increases the stress experienced by center hanger 36 and subframe 16, including main member 74.

Moreover, first prior art spring axle/suspension system 10 includes other disadvantages. For example, connection point 70 between rear radius rod 66 and center hanger 36 is vertically lower than connection point 76 between front radius rod 64 and front hanger 28. This difference in connection heights may cause improper alignment of front axle 20F and rear axle 20R relative to one another when the vehicle executes a tight turning maneuver, which undesirably causes the vehicle tires to steer out of parallel alignment relative to one another and thereby undesirably increases tire wear. Moreover, each respective front end 32, 46 and rear end 34, 48 of each respective top spring 26T, 42T of front and rear spring stacks 24, 40 ride on cams or slipper blocks (not shown) and thus float relative to subframe 16, rather than being fixed in their respective positions. This construction of spring stacks 24, 40 creates a propensity for the springs to lift off of their respective cams or slipper blocks when the vehicle executes a maneuver that creates roll forces, which is a phenomenon known in the art as “spring lash” and undesirably decreases the roll stability of the vehicle.

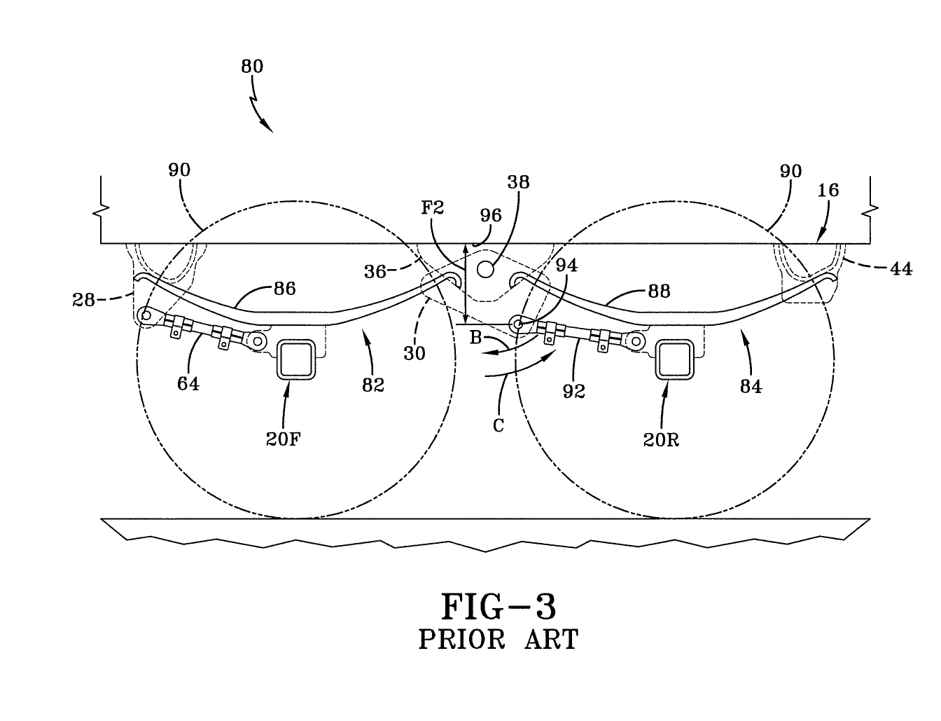

Turning now to FIG. 3, a second prior art spring axle/suspension system is indicated generally at 80. Second prior art spring axle/suspension system 80 is generally similar in design and construction in most respects to first prior art spring axle/suspension system 10, with particular exceptions being that the second prior art spring axle/suspension system includes a front axle/suspension system 82, which in turn includes a pair of transversely-spaced, longitudinally-extending mechanical single front springs 86 that connect to a front axle 20F, and a rear axle/suspension system 84, which in turn includes a pair of transversely-spaced, longitudinally-extending mechanical single rear springs 88 that connect to a rear axle 20R. In addition, rear axle/suspension system 84 includes a pair of transversely spaced rear radius rods 92 that are each connected to a respective equalizer 30, rather than to a respective center hanger 36.

Inasmuch as each one of the pair of front springs 86 is identical to the other, each one of the pair of rear springs 88 is identical to the other, and each one of the pair of radius rods 92 is generally identical to the other, only one of each will be described herein. It is understood that second prior art spring axle/suspension system 80 is shown in FIG. 3 in what is referred to in the art as an over-slung configuration, in which front spring 86 is disposed above front axle 20F and rear spring 88 is disposed above rear axle 20R.

Second prior art spring axle/suspension system 80 generally reduces inter-axle load transfer due to braking when compared to first prior art spring axle/suspension system 10. More particularly, during a heavy brake application, when equalizer 30 attempts to pivot in a clockwise manner, indicated by arrow B in FIG. 3, due to the forces that are generated, the attachment of rear radius rod 92 to the equalizer produces a counter-rotating moment of the equalizer, indicated by arrow C. Counter-rotating moment C reduces the transfer of loads to rear axle 20R, maintains the loads on front axle 20F, and thus desirably reduces inter-axle load transfer due to braking. This reduction of inter-axle load transfer maintains the effectiveness of the front axle for braking, thereby desirably maintaining the braking or stopping efficiency of the vehicle.

While second prior art spring axle/suspension system 80 reduces inter-axle load transfer due to braking, it still requires the use of radius rods 64, 92, which undesirably add weight and cost to the system. In addition, second prior art spring axle/suspension system 80 employs a relatively low vertical connection point 94 between rear radius rod 92 and equalizer 30. Because equalizer 30 is connected to center hanger 36 by pin and bushing assembly 38, which in turn is connected to vehicle subframe 16, the vertical distance between point 94 and interface 96 of the center hanger and the subframe, indicated by arrow F2, is undesirably increased in a manner similar to that as described above for first prior art spring axle/suspension system 10. This increased distance F2 undesirably increases the moment of force and thus the stress experienced by center hanger 36 and subframe 16.

Moreover, with continuing reference to FIG. 3 and second prior art spring axle/suspension system 80, the relatively low vertical position of connection point 94 between rear radius rod 92 and equalizer 30 may lead to undue wear of tires 90 as the vehicle travels over-the-road. More particularly, as the vehicle operates, tires 90 encounter surface irregularities such as bumps and holes, and equalizer 30 pivots to balance the load between front axle 20F and rear axle 20R. When equalizer 30 pivots, rear radius rod 92 experiences significant movement in an arcuate fashion by virtue of its connection to the equalizer. Because rear radius rod 92 is pivotally affixed to rear axle 20R, the significant arcuate movement of the rear radius rod forces the rear axle to move in a fore or aft direction each time tires 90 encounter a surface irregularity. When tires 90 on one side of the vehicle contact a surface irregularity and the tires on the other side of the vehicle do not, which is a common event, the subsequent pivoting of equalizer 30 and resulting significant arcuate movement of rear radius rod 92 causes one side of axle 20R to move in a fore or aft direction, while the other side of the axle does not move in the same manner. This uneven movement of one side of rear axle 20R relative to the other side of the axle temporarily steers or “bump steers” the wheels mounted on the axle and tires 90 substantially out of proper alignment with respect to vehicle subframe 16, which causes the tires to undesirably experience premature wear.

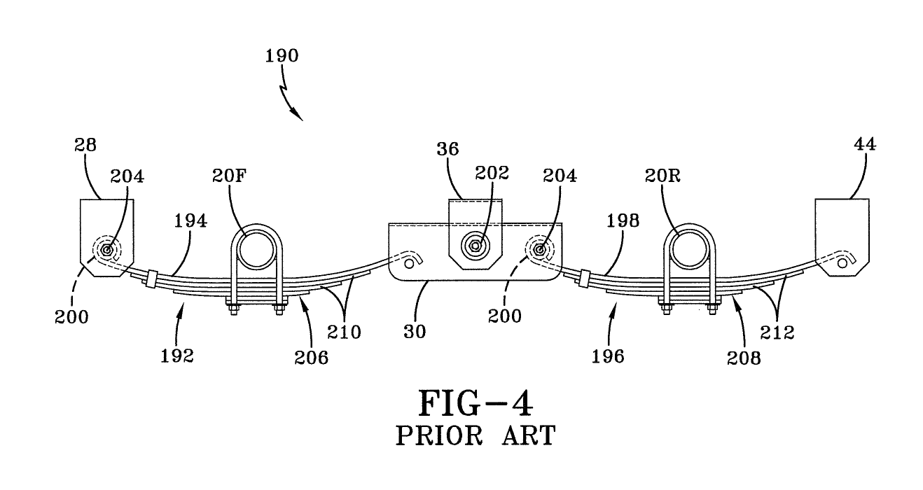

Other prior art spring axle/suspension system designs have employed constructions that attempt to eliminate radius rods 64, 66, 92 of first and second prior art spring axle/suspension systems 10, 80, respectively. For example, referring now to FIG. 4, a third prior art spring axle/suspension system is indicated generally at 190. Third prior art spring axle/suspension system 190 is generally similar in design and construction in most respects to first prior art spring axle/suspension system 10, with a particular exception being that the third prior art spring axle/suspension system does not include front or rear radius rods, 64, 66.

More specifically, third prior art spring axle/suspension system 190 includes a front axle/suspension system 192, which in turn includes a pair of transversely-spaced, longitudinally-extending mechanical spring suspension assemblies 206, which connect to a front axle 20F, and a rear axle/suspension system 196, which in turn includes a pair of transversely-spaced, longitudinally-extending mechanical spring suspension assemblies 208, which connect to a rear axle 20R. Inasmuch as each one of the pair of front mechanical spring suspension assemblies 206 is identical to the other, and each one of the pair of rear mechanical spring suspension assemblies 208 is identical to the other, only one of each will be described herein.

Front mechanical spring suspension assembly 206 includes a leaf spring set 194, which in turn includes a plurality of leaf springs 210. Rear mechanical spring suspension assembly 208 includes a leaf spring set 198, which in turn includes a plurality of leaf springs 212. It is to be understood that, while third prior art spring axle/suspension system 190 is shown in FIG. 4 as what is referred to in the art as an under-slung configuration, in which each spring set 194, 198 is disposed beneath its respective axle 20F, 20R, rather than an over-slung configuration as shown above in FIGS. 1-3 for first and second prior art spring axle/suspension systems 10, 80, respectively, the behavior of the third prior art spring axle/suspension system for inter-axle load transfer is essentially the same in an under-slung configuration and an over-slung configuration.

Front mechanical spring set 194 of front axle/suspension system 192 extends between and is attached to front hanger 28 and equalizer 30, and is connected to front axle 20F. The front end of a selected one of the springs of front mechanical spring set 194 is formed with a spring eye 200, which receives a pin and bushing assembly 204 to pivotally connect the spring eye to front hanger 28. The rear end of a selected one of the springs of front mechanical spring set 194 rests on and engages a cam or slipper block (not shown) mounted in equalizer 30. Rear mechanical spring set 198 of rear suspension assembly 196 extends between and is connected to equalizer 30 and rear hanger 44, and is connected to rear axle 20R. The front end of a selected one of the springs of rear mechanical spring set 198 is formed with a spring eye 200, which receives a pin and bushing assembly 204 to pivotally connect the spring eye to equalizer 30. The rear end of a selected one of the springs of rear mechanical spring set 198 rests on and engages a cam or slipper block (not shown) mounted in rear hanger 44.

Because third prior art spring axle/suspension system 190 does not include radius rods 64, 66, 92, the system has to contend with greater axle rotation due to braking, which is also known as brake wind-up, and thus tends to experience more inter-axle load transfer due to braking. More particularly, systems such as third prior art spring axle/suspension system 190 have employed a design that locates eyes 200 of mechanical springs 194, 198 directly in horizontal alignment with an equalizer pin and bushing assembly 202. Such horizontal alignment of spring eyes 200 with equalizer pin and bushing assembly 202 precludes counter-rotational movement of equalizer 30. As a result, when axles 20F, 20R experience axle rotation due to braking, equalizer 30 is unable to rotate. When equalizer 30 is unable to rotate, it is unable to counteract such brake wind-up, thereby enabling axle/suspension system 190 to experience increased inter-axle load transfer due to braking. In addition, prior art spring axle/suspension systems that do not include radius rods 64, 66, 92, such as third prior art spring axle/suspension system 190, experience difficulty in properly aligning axles 20F, 20R.

Therefore, there is a need in the art for a spring axle/suspension system that overcomes the disadvantages of prior art systems by reducing inter-axle load transfer due to braking without the use of radius rods, improving the distribution of forces encountered by the axle/suspension system, decreasing the stresses placed on the vehicle subframe, and reducing brake wind-up, while being lighter in weight and more economical than prior art spring axle/suspension systems. The spring axle/suspension system of the present invention satisfies this need, as will now be described.

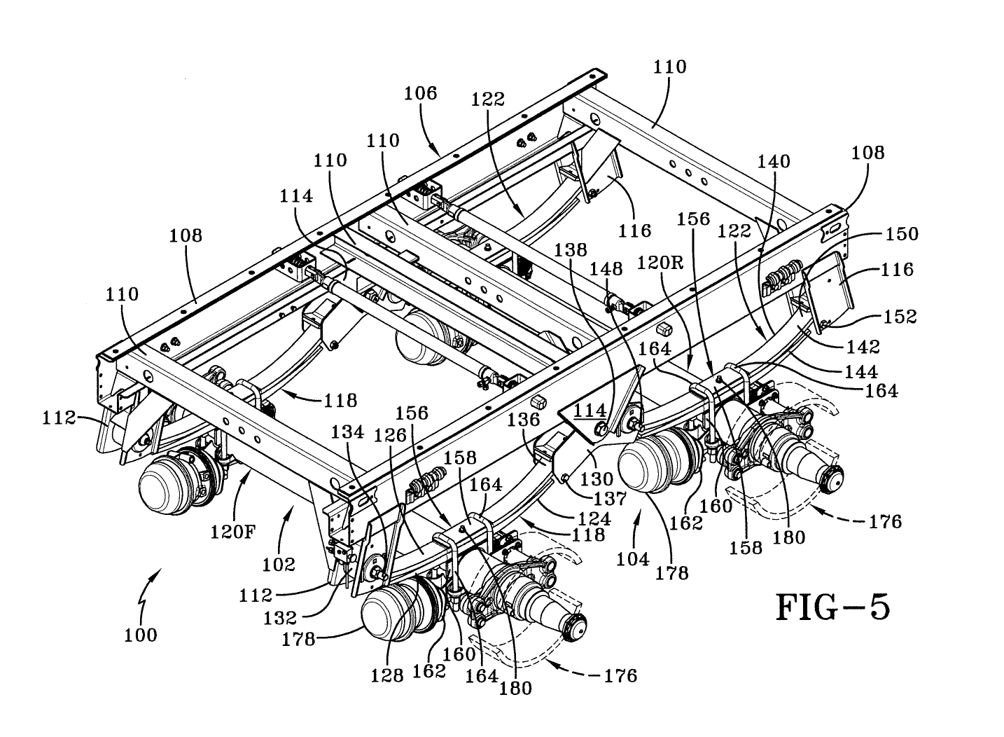

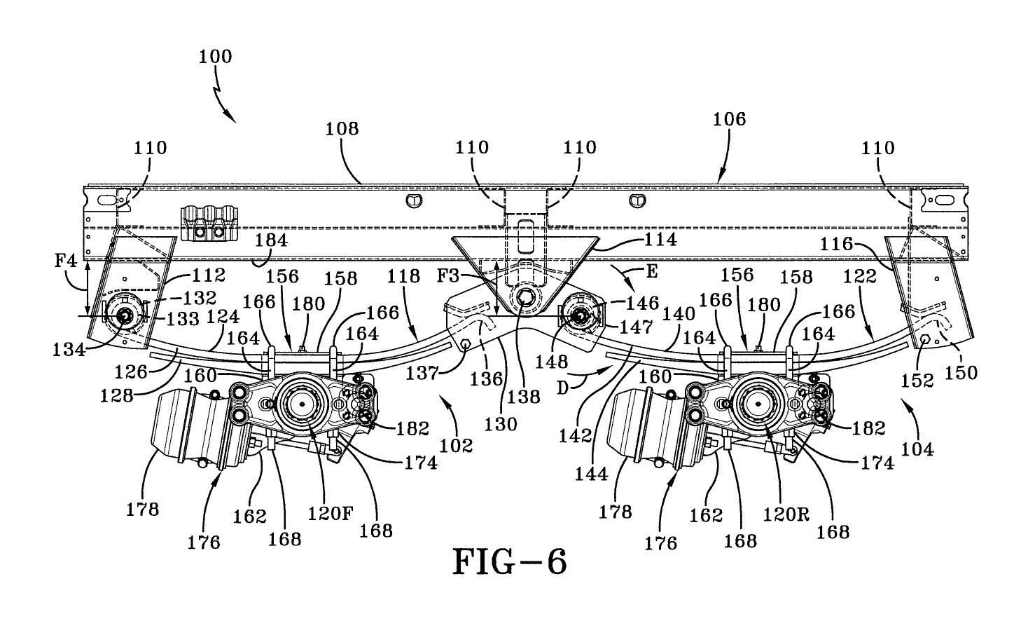

Turning to the drawings of the present invention, wherein the illustrations are for showing the preferred embodiment of the invention, and not for limiting the same, FIGS. 5-7 show an exemplary embodiment of a spring axle/suspension system for a heavy-duty vehicle of the present invention, indicated generally at 100. Referring now to FIGS. 5 and 6, spring axle/suspension system 100 is a tandem system, utilizing a front axle/suspension system 102 and a rear axle/suspension system 104, each of which is connected to and depends from a vehicle subframe 106.

It is to be understood that, as mentioned above, in some heavy-duty vehicles, the axle/suspension systems are connected directly to the primary frame of the vehicle, while in other heavy-duty vehicles, the primary frame of the vehicle supports a movable or non-movable subframe, and the axle/suspension systems connect directly to the subframe. For the purpose of convenience, reference herein will be made to subframe 106, with the understanding that such reference is by way of example, and that the present invention applies to heavy-duty vehicle primary frames, movable subframes and non-movable subframes.

Subframe 106 includes a pair of longitudinally-extending, parallel, transversely-spaced elongated main members 108. A plurality of longitudinally-spaced parallel cross members 110 extend transversely between and are attached to main members 108. Pairs of transversely spaced hangers, including front hangers 112, center hangers 114, and rear hangers 116, are mounted on and depend from main members 108 and selected ones of cross members 110. It should be noted that, while hangers 112, 114, 116 are often considered to be part of subframe 106 once they are connected to main members 108 and selected ones of cross members 110, they are typically engineered as part of spring axle/suspension system 100.

Front axle/suspension system 102 includes a pair of transversely-spaced, longitudinally-extending mechanical spring suspension assemblies 118, which connect to a front axle 120F. Similarly, rear axle/suspension system 104 includes a pair of transversely-spaced, longitudinally-extending mechanical spring suspension assemblies 122, which connect to a rear axle 120R. Inasmuch as each one of the pair of front mechanical spring suspension assemblies 118 is identical to the other, and each one of the pair of rear mechanical spring suspension assemblies 122 is identical to the other, only one of each will be described herein.

Front mechanical spring suspension assembly 118 includes a pair of transversely-spaced leaf spring sets or stacks 124, and rear mechanical spring suspension assembly 122 includes a pair of transversely-spaced leaf spring sets or stacks 140. It is to be noted that spring axle/suspension system 100 of the present invention is shown in FIGS. 5-7 in what is referred to in the art as an over-slung configuration, in which front spring stack 124 is disposed above front axle 120F, and rear spring stack 140 is disposed above rear axle 120R. It is to be understood that axle/suspension system 100 of the present invention may be used in an over-slung or under-slung configuration without affecting the overall concept or operation of the invention.

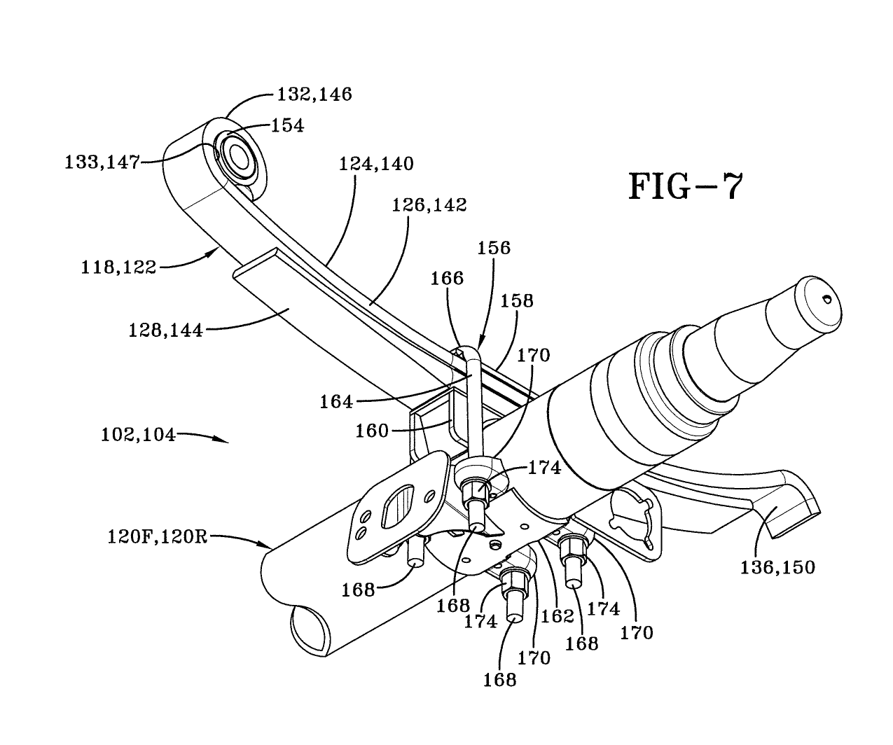

Front spring stack 124 preferably includes a top leaf spring 126 and a bottom leaf spring 128. Top leaf spring 126 preferably is formed with a uniform linear taper in its thickness at each end, that is, a progression from a thicker center to thinner ends, which is known in the art as a straight taper, and extends longitudinally between front hanger 112 and an equalizer or rocker 130. More particularly, and with additional reference to FIG. 7, a front end 132 of top spring 126 is formed with a spring eye 133 that is configured to receive a bushing 154 and a pin or bolt 134. Pin 134 pivotally connects spring eye 133 to front hanger 112, so that front end 132 of top spring 126 is securely and firmly pivotally connected to the front hanger. A rear end 136 of top spring 126 is formed to enable the rear end of the top spring to rest on and engage a cam 137 that is mounted in equalizer 130. Equalizer 130 in turn is pivotally connected to center hanger 114 by a pin and bushing assembly 138. This construction enables top leaf spring 126 of front spring stack 124, and thus the front spring stack, to be securely pivotally connected to front hanger 112, while enabled to float or slide at equalizer 130. As known in the art, equalizer 130 provides a connection between front and rear suspension assemblies 118, 122, respectively, and is able to pivot in order to help balance the loads between front and rear axles 120F, 120R.

Rear spring stack 140 preferably includes a top leaf spring 142 and a bottom leaf spring 144. Top rear leaf spring 142 preferably is formed with a uniform linear taper in its thickness at each end, that is, a progression from a thicker center to thinner ends, which is known in the art as a straight taper, and extends longitudinally between equalizer 130 and rear hanger 116. More particularly, a front end 146 of top spring 142 is foamed with a spring eye 147, which receives bushing 154 (FIG. 7) and a pin or bolt 148. Pin 148 pivotally connects spring eye 147 to equalizer 130, so that front end 146 of top rear spring 142 is securely and firmly pivotally connected to the equalizer. A rear end 150 of top spring 142 is formed to enable the rear end of the top spring to rest on and engage a cam 152 that is mounted in rear hanger 116. This construction enables top leaf spring 142 of rear spring stack 140, and thus the rear spring stack, to be securely pivotally connected to equalizer 130, while enabled to float or slide at rear hanger 116.

With particular reference now to FIG. 7, each spring stack 124, 140 is clamped to its respective axle 120F, 120R by a clamp assembly 156. More particularly, clamp assembly 156 includes an upper plate 158, a top axle seat 160, an integrated brake component mounting bracket that includes a bottom axle seat 162, and a pair of U-bolts 164. Upper plate 158 is disposed on an upper surface of each top leaf spring 126, 142 at about the longitudinal midpoint of each respective spring. Top axle seat 160 is disposed between a bottom surface of each bottom leaf spring 128, 144 and the upper portion of each respective axle 120F, 120R in general vertical alignment with upper plate 158. Top axle seat 160 preferably is welded to each respective axle 120F, 120R. Integrated brake component mounting bracket/bottom axle seat 162 is disposed on a lower portion of each axle 120F, 120R in vertical alignment with upper plate 158 and top axle seat 160, and preferably is welded to each respective axle. A curved apex 166 of each U-bolt 164 engages and secures upper plate 158, while each end 168 of each U-bolt passes through a respective boss 170 formed in integrated brake component mounting bracket/bottom axle seat 162. In this manner, upper plate 158, top leaf spring 126, 142, bottom leaf spring 128, 144, top axle seat 160, axle 120F, 120R, and integrated brake component mounting bracket/bottom axle seat 162 are rigidly clamped together when nuts 174 are tightened onto U-bolt ends 168. Preferably, a center bolt 180 extends through each respective upper plate 158, top leaf spring 126, 142, bottom leaf spring 128, 144 and top axle seat 160 to provide an additional interconnection of the springs and clamp assembly 156.

For the purpose of relative completeness, components of a brake system 176, including a brake chamber 178 and an S-cam assembly 182, are shown in FIGS. 5 and 6 mounted on integrated brake component mounting bracket/bottom axle seat 162. Integrated brake component mounting bracket/bottom axle seat 162 is more fully described in a separate application being filed concurrently herewith by the same assignee, Hendrickson USA, L.L.C.

In this manner, spring axle/suspension system for a heavy-duty vehicle 100 of the present invention employs a spring eye 133 on top front spring 126 to provide a connection of front suspension assembly 118 to front hanger 112 that is a pivotal connection about a fixed point, referred to herein as a fixed pivotal connection. Spring axle/suspension system 100 also employs a spring eye 147 on top rear spring 142 to provide a fixed pivotal connection of rear suspension assembly 122 to equalizer 130. While the front end of each respective front and rear suspension assembly 118, 122 employs a fixed pivotal connection, the rear end of each suspension assembly is slideably disposed on each respective cam 137, 152. Spring axle/suspension system 100 utilizes an optimum positioning of each spring eye 133, 147, and particularly of the spring eye of top rear leaf spring 142, to enable effective use of the spring eyes so that radius rods 64, 66, 92 of first and second prior art spring axle/suspension systems (FIGS. 1-3) are eliminated, while also reducing inter-axle load transfer due to braking and improving force distribution.

More particularly, and with particular reference to FIG. 6, spring eye 147 of top rear leaf spring 142 is connected directly to equalizer 130, and is located at an optimum vertical and horizontal position to reduce inter-axle load transfer and enable distribution of forces encountered by spring axle/suspension system 100. The vertical position of spring eye 147 is lower than pin and bushing assembly 138, which is the pivot point of equalizer 130 relative to center hanger 114. Forces from a heavy brake application cause equalizer 130 to pivot in a clockwise direction represented by arrow E, which if left unchecked, results in increased load on rear axle 120R and decreased load on front axle 120F. However, by being below the pivot point of equalizer 130, spring eye 147 provides a counter-rotation, indicated by arrow D. Spring eye counter-rotation D reduces the load gained by rear axle 120R and reduces the decrease of load on front axle 120F that is imparted by clockwise-acting braking forces E. In this manner, the counter-rotation enabled by spring axle/suspension system 100 desirably reduces inter-axle load transfer due to braking.

In addition, the vertical distance between spring eye 147 of top rear spring 142 and bottom 184 of subframe main member 108, indicated by arrow F3 in FIG. 6, is less than vertical distance F1 between rear radius rod 66 and subframe 16 of first prior art spring axle/suspension system 10 (FIG. 2). By reducing vertical distance F3 between the pivotal connection of rear suspension assembly 140, that is, spring eye 147, and bottom 184 of subframe main member 108, the vertical moment arm and the resulting moment of force at center hanger 114 is decreased. Reduction of this vertical moment arm in turn reduces the force acting at the interface between center hanger 114 and subframe main member 108, which reduces the stress on these components and extends each of their respective lives.

Spring axle/suspension system 100 also provides a vertical distance between spring eye 133 of top front spring 126 and bottom 184 of subframe main member 108, indicated by arrow F4 in FIG. 6, that is less than vertical distance F1 between rear radius rod 66 and subframe 16 of first prior art spring axle/suspension system 10. By reducing vertical distance F4 between spring eye 133 and bottom 184 of subframe main member 108, the vertical moment arm and the resulting moment of force at front hanger 112 is decreased, which in turn reduces the force acting at the interface between the front hanger subframe main member 108, extending the lives of the front hanger and the subframe main member.

The optimum positioning of spring eye 147 of top rear spring 142 also includes the horizontal position of the spring eye. More particularly, spring eye 147 is horizontally positioned rearwardly of pin and bushing assembly 138, which is the pivot point of equalizer 130 relative to center hanger 114. The location of spring eye 147 rearwardly of pin and bushing assembly 138 enables the spring eye to be moved vertically closer to subframe main member 108 to reduce the vertical distance between the spring eye and the main member, which decreases the moment arm and the resulting moment of force, as described above.

Moreover, the horizontal position of spring eye 147 reduces tire wear. More particularly, when the vehicle travels over-the-road and tires 90 (FIG. 3) encounter surface irregularities, equalizer 130 pivots to balance the load between front axle 120F and rear axle 120R. When equalizer 130 pivots, spring eye 147 moves in an arcuate manner, but such movement is relatively smaller or less when compared to the arcuate movement described above for rear radius rod 92 of second prior art spring axle/suspension system 80 (FIG. 3). As a result, rear axle 120R is not forced to significantly move in a fore or aft direction each time tires 90 encounter a surface irregularity, which desirably decreases premature tire wear.

The use of spring eyes 133, 147 secures each respective suspension assembly 118, 122 to corresponding front and center hangers 112, 114, which improves the roll stability of the vehicle. More particularly, spring eye 133 of top front spring 126 securely connects front top spring front end 132 to front hanger 112 and spring eye 147 of top rear spring 142 securely connects rear top spring front end 146 to equalizer 130, which is in turn connected to center hanger 114, so that in an extreme roll event, only rear end 136, 150 of each respective top spring is able to lift off of its respective cam 137, 152. By permitting only rear end 136, 150 of each respective top spring 126, 142 to lift off its respective cam 137, 152, the amount of spring lash encountered by spring axle/suspension system 100 is reduced when compared to first and second prior art spring axle/suspension systems 10, 80 (FIGS. 1-3), in which both ends of springs 26, 42, 86, 88 ride on cams or slipper blocks. Such a reduction in spring lash by spring axle/suspension system 100 of the present invention improves the roll stability of the vehicle.

In addition, the use of spring eyes 133, 147 to secure each respective suspension assembly 118, 122 to corresponding front and center hangers 112, 114 improves the steer characteristics of spring axle/suspension system 100. More particularly, the vertical location of spring eye 133 of top front spring 126 relative to subframe main member 108 preferably is similar to that of spring eye 147 of top rear spring 142, so that a generally uniform geometry between front axle/suspension system 102 and rear axle/suspension system 104 is provided. This generally uniform geometry enables proper alignment of front axle 120F and rear axle 120R relative to one another when the vehicle executes an in-phase roll maneuver, such as what typically occurs at a highway cloverleaf interchange, which prevents tires 90 (FIG. 3) from steering out of parallel to one another, thereby improving the life of the tires.

As mentioned above, front suspension assembly 118 and rear suspension assembly 122 preferably each include two leaf springs, that is, top leaf spring 126, 142 and bottom leaf spring 128, 144, respectively. Each top leaf spring 126, 142 and each bottom leaf spring 128, 144 preferably is formed with a uniform linear taper in its thickness at each end, that is, a progression from a thicker center to thinner ends, which is known in the art as a straight taper. Alternatively, each top leaf spring 126, 142 and/or each bottom leaf spring 128, 144 may optionally be formed with a different taper, such as a non-uniform or non-linear taper, or without a taper. The preferred configuration of two spring leaves 126, 128 and 142, 144 provides a softer, more comfortable ride when the vehicle is unloaded or is only partially loaded with freight, such as at half of its capacity, when compared to configurations employing three or more spring leaves, such as first and third prior art spring axle/suspension systems 10, 190 (FIGS. 1-3). The preferred configuration of two spring leaves 126, 128 and 142, 144 also provides adequate stiffness when the vehicle is fully loaded with freight, in contrast to single-leaf configurations, such as second prior art spring axle/suspension system 80 (FIG. 4), which may not provide adequate stiffness when the vehicle is fully loaded with freight.

In addition to saving weight and expense, the elimination of radius rods 64, 66, 92 (FIGS. 1-3) from spring axle/suspension system 100 of the present invention contributes to clearance that enables the use of integrated brake component mounting bracket/bottom axle seat 162. As described above, integrated brake component mounting bracket/bottom axle seat 162 is more fully described in a separate application being filed concurrently herewith by the same assignee, Hendrickson USA, L.L.C.

In this manner, the use of spring eyes 133, 147 at optimum locations relative to vehicle subframe 106 enables spring axle/suspension system 100 of the present invention to eliminate radius rods 64, 66, 92 of first and second prior art spring axle/suspension systems 10, 80 (FIGS. 1-3), while desirably providing reduced inter-axle load transfer due to braking. The elimination of radius rods 64, 66, 92, enables spring axle/suspension system 100 to be more cost-effective and lighter in weight than first and second prior art spring axle/suspension systems 10, 80, respectively, while also eliminating the maintenance and replacement costs associated with radius rods. Also, by eliminating radius rods 64, 66, 92, spring axle/suspension system 100 of the present invention desirably reduces the number of pivot connections and accompanying bushings from the ten employed in prior art spring axle/suspension systems 10, 80 to only six.

The reduced inter-axle load transfer due to braking that is achieved by spring axle/suspension system 100 of the present invention through the use of and optimal positioning of spring eyes 133, 147 improves the stopping efficiency of the vehicle and reduces tire wear. In addition, the elimination of radius rods 64, 66, 92 and the optimal vertical positioning of spring eyes 133, 147 relatively close to bottom 184 of subframe main member 108 provides improved force distribution by spring axle/suspension system 100 and reduction of the forces at the interface between front hanger 112 and subframe 106 and at the interface between center hanger 114 and the subframe, which desirably decreases the stress on the front and center hangers and/or components of the subframe.

When compared to second prior art spring axle/suspension system 80 (FIG. 3), the optimum positioning of spring eyes 133, 147, and particularly of the spring eye of top rear spring 142, enables spring axle/suspension system 100 to reduce arcuate motion and the resulting fore-aft movement of rear axle 120R when the vehicle encounters surface irregularities, which decreases tire wear.

Also, the vertical position of spring eye 147 of top rear spring 142 reduces the amount of brake wind-up that is experienced by spring axle/suspension system 100 when compared to prior art spring axle/suspension systems, such as third prior art spring axle/suspension system 190 (FIG. 4). More particularly, the design of third prior art axle/suspension system 190 locates the front end 202 of rear spring 198 directly in horizontal alignment with equalizer pin and bushing assembly 202. This horizontal alignment precludes counter-rotational movement of equalizer 30 that would be necessary to counteract rotation of rear axle 20R due to braking, which is known in the art as brake wind-up. Spring axle/suspension system 100 of the present invention includes a vertical position of spring eye 147 of top rear spring 142 that is lower than equalizer pin and bushing assembly 138, and thus is not directly in horizontal alignment with the equalizer pin and bushing assembly. Such a vertical position of spring eye 147 enables counter-rotation of equalizer 130, thereby reducing rotation of rear axle 120R during a heavy brake application, which in turn reduces brake wind-up and the resulting stresses on axle/suspension system 100 when compared to third prior art spring axle/suspension system 190.

Spring axle/suspension system 100 of the present invention also provides improved roll stability over prior art first and second spring axle/suspension systems 10, 80, respectively. That is, prior art spring axle/suspension system spring stacks 24, 40, 86, 88 of first and second spring axle/suspension systems 10, 80, respectively, are not fixed and thus experience a significant propensity to lift off of their respective cams or slipper blocks when the vehicle experiences roll forces, which is a phenomenon known in the art as spring lash. Such spring lash reduces the roll stability of first and second prior art spring axle/suspension systems 10, 80. Through the use of spring eyes 133, 147, each respective spring stack 124, 140 of spring axle/suspension system 100 is fixed at its front end, which decreases spring lash when the vehicle experiences roll forces. The decreased spring lash of spring stacks 124, 140 enables improved roll stability of spring axle/suspension system 100.

Moreover, by employing a generally similar vertical positioning of spring eye 133 of top front spring 126 and spring eye 147 of top rear spring 142, each respective front and rear axle/suspensions 102, 104 of spring axle/suspension system 100 have a symmetrical geometry. This symmetrical geometry maintains optimum alignment of front and rear axles 120F, 120R, respectively, which reduces the scrubbing of tires 90 (FIG. 3) during a maneuver such as a clover leaf interchange, which in turn decreases tire wear.

It is to be noted that the principles of the invention can be applied to any type of spring axle/suspension system without affecting the overall concept or operation of the invention. For example, other numbers, styles and/or configurations of spring leaves than those shown and described herein may be used without affecting the overall concept or operation of the present invention, including overslung configurations and underslung configurations. In addition, the invention applies to various types of frames used for heavy-duty vehicles, including primary frames that do not support a subframe and primary frames and/or floor structures that do support a movable or non-movable subframe. The invention also applies to various brake systems, including systems other than those shown and described above.

Accordingly, the improved mechanical spring axle/suspension system is simplified, provides an effective, safe, inexpensive, and efficient structure which achieves all the enumerated objectives, provides for eliminating difficulties encountered with prior art mechanical spring axle/suspension systems, and solves problems and obtains new results in the art.

In the foregoing description, certain terms have been used for brevity, clarity and understanding; but no unnecessary limitations are to be implied therefrom beyond the requirements of the prior art, because such terms are used for descriptive purposes and are intended to be broadly construed. Moreover, the present invention has been described with reference to an exemplary embodiment. It shall be understood that this illustration is by way of example and not by way of limitation, as the scope of the invention is not limited to the exact details shown or described. Potential modifications and alterations will occur to others upon a reading and understanding of this disclosure, and it is understood that the invention includes all such modifications and alterations and equivalents thereof.

Having now described the features, discoveries and principles of the invention, the manner in which the improved mechanical spring axle/suspension system is constructed, arranged and used, the characteristics of the construction and arrangement, and the advantageous, new and useful results obtained; the new and useful structures, devices, elements, arrangements, parts and combinations are set forth in the appended claims.

What is claimed is:

1. A mechanical spring axle/suspension system for a heavy-duty vehicle, said vehicle having a frame including:
a pair of spaced-apart, parallel, elongated, and longitudinally-extending main members;
at least a pair of transverse cross members extending between and being attached to said main members;
a pair of front hangers, each one of said front hangers being attached to and depending from a front end of a respective one of said main members;
a pair of center hangers, each one of said center hangers being attached to and depending from a center portion of a respective one of said main members;
a pair of rear hangers, each one of said rear hangers being attached to and depending from a rear end of a respective one of said main members; and
a pair of equalizers, each one of said equalizers being pivotally connected to a respective one of said center hangers, said mechanical spring axle/suspension system comprising:
a front axle/suspension system, said front axle/suspension system including:
a pair of transversely-spaced front leaf spring stacks, wherein each front spring stack includes at least one leaf spring extending longitudinally between a respective one of said front hangers and a respective one of said equalizers;
said at least one leaf spring of said front spring stack including a front end formed with a spring eye, wherein said spring eye is pivotally connected to said respective one of each of said front hangers;
said at least one leaf spring of said front spring stack including a rear end slideably disposed on a cam mounted in said respective one of said equalizers; and
a front axle extending between and being rigidly connected to each one of said pair of front leaf spring stacks; and
a rear axle/suspension system, said rear axle/suspension system including:
a pair of transversely-spaced rear leaf spring stacks, wherein each rear spring stack includes at least one leaf spring extending longitudinally between a respective one of said equalizers and a respective one of said rear hangers;
said at least one leaf spring of said rear spring stack including a front end formed with a spring eye, wherein said spring eye is pivotally connected to said respective one of each of said equalizers, and wherein a vertical position of said pivotal connection of the at least one leaf spring of the rear spring stack to the respective one of the equalizers is below a vertical position of said pivotal connection of said respective equalizer to said respective one of said center hangers;
said at least one leaf spring of said rear spring stack including a rear end slideably disposed on a cam mounted in said respective one of said rear hangers; and
a rear axle extending between and being rigidly connected to each one of said pair of rear leaf spring stacks, whereby inter-axle load transfer encountered by said mechanical spring axle/suspension system is minimized.

2. The mechanical spring axle/suspension system for a heavy-duty vehicle of claim 1, wherein a vertical distance between said pivotal connection of said at least one leaf spring of said rear spring stack to a lower surface of a respective one of said main members is less than a vertical distance between a prior art rear radius rod and said main member lower surface, whereby forces acting at an interface between a respective one of said pair of said center hangers and said main member are reduced.

3. The mechanical spring axle/suspension system for a heavy-duty vehicle of claim 1, wherein a horizontal position of said pivotal connection of said at least one leaf spring of said rear spring stack to said respective one of said equalizers is rearward of a horizontal position of said pivotal connection of the respective equalizer to said respective one of said center hangers.

4. The mechanical spring axle/suspension system for a heavy-duty vehicle of claim 1, wherein a vertical distance between said pivotal connection of said at least one leaf spring of said front spring stack to a lower surface of a respective one of said main members is less than a vertical distance between a prior art rear radius rod and said main member lower surface, whereby forces acting at an interface between a respective one of said pair of said front hangers and said main member are reduced.

5. The mechanical spring axle/suspension system for a heavy-duty vehicle of claim 1, wherein said system is free of radius rods.

6. The mechanical spring axle/suspension system for a heavy-duty vehicle of claim 1, wherein said pivotal connection of each one of said spring eyes includes a bushing and pin.

7. The mechanical spring axle/suspension system for a heavy-duty vehicle of claim 1, wherein said frame is a primary frame of said vehicle.

8. The mechanical spring axle/suspension system for a heavy-duty vehicle of claim 1, wherein said frame is a subframe of said vehicle.

9. The mechanical spring axle/suspension system for a heavy-duty vehicle of claim 1, wherein said front axle is disposed below each one of said front spring stacks, and said rear axle is disposed below each one of said rear spring stacks.

10. The mechanical spring axle/suspension system for a heavy-duty vehicle of claim 1, wherein said front axle is disposed above each one of said front spring stacks, and said rear axle is disposed above each one of said rear spring stacks.

11. The mechanical spring axle/suspension system for a heavy-duty vehicle of claim 1, wherein said at least one leaf spring of said front spring stack is formed with a straight taper.

12. The mechanical spring axle/suspension system for a heavy-duty vehicle of claim 1, wherein said at least one leaf spring of said rear spring stack is formed with a straight taper.

13. The mechanical spring axle/suspension system for a heavy-duty vehicle of claim 1, wherein said front spring stack includes at least two leaf springs.

14. The mechanical spring axle/suspension system for a heavy-duty vehicle of claim 1, wherein said rear spring stack includes at least two leaf springs.

15. The mechanical spring axle/suspension system for a heavy-duty vehicle of claim 1, wherein said rigid connection of each spring stack to its respective axle is provided by a clamp assembly, said clamp assembly including:
an upper plate disposed on an upper surface of said respective spring stack;
a top axle seat disposed between a lower surface of said respective spring stack and an upper portion of said respective axle in general vertical alignment with said upper plate;
a bottom axle seat disposed on a lower portion of said respective axle in general vertical alignment with said upper plate and said top axle seat;
at least one U-bolt, whereby said at least one U-bolt secures said upper plate, said spring stack, said top axle seat, said axle, and said bottom axle seat together.

16. The mechanical spring axle/suspension system for a heavy-duty vehicle of claim 15, wherein said top axle seat and said bottom axle seat are welded to said respective axle.

17. The mechanical spring axle/suspension system for a heavy-duty vehicle of claim 15, wherein said bottom axle seat is an integrated brake component mounting bracket.

18. The mechanical spring axle/suspension system for a heavy-duty vehicle of claim 1, wherein said mechanical spring axle/suspension system reduces a number of pivot connections and accompanying bushings from a prior art amount of ten to about six.
